(19) United States
(12) Patent Application Publication
(10) Pub. No.: US 2005/0235338 A1
(43) Pub. Date: Oct. 20, 2005

(54) Home network media server with a jukebox for enhanced user experience

(75) Inventors: Salim S. AbiEzzi, Sammamish, WA (US); Ralph Allen Lipe, Yarrow Point, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 11/152,459

(22) Filed: Jun. 14, 2005

Related U.S. Application Data
(63) Continuation of application No. 10/736,055, filed on Dec. 15, 2003.

(51) Int. Cl. G11B 21/08; H04N 7/173; G11B 17/22; H04N 7/16

(52) U.S. Cl. 725/142; 725/135; 725/134

(57) ABSTRACT

A DVD jukebox or the like is integrated with a home network and serves as a centralized storage of multiple video/audio titles that can be selected and played on display devices, such as televisions, at different locations in the home. The jukebox is connected to a media server on the home network. The media server controls the jukebox and functions as its proxy to allow discovery and control of the jukebox by other devices on the home network. The media server generates a directory of the titles stored in the jukebox, which is sent via the home network to a media client connected to the display device. The media client presents an interactive user interface to allow the user to navigate the titles in the jukebox and select a title for viewing on the display device.

### TECHNICAL FIELD

This invention relates generally to computer networking and home entertainment, and more particularly to a system and method of integrating home entertainment and home networking to provide enhanced user experience.

### BACKGROUND OF THE INVENTION

Watching movies on televisions has become a major form of home entertainment. The high quality video images and multi-channel audio provided by digital storage media such as Digital Video Discs (DVD's) allow users to enjoy theater-quality viewing experience from the convenience and comfort of the home, and have created a significant market for home theater implementations.

People who have a large collection of DVD's are faced with the needs to allocate the space to store the DVD's and to organize and sort the various titles in a manner that allows desired titles to be easily found. A user with many DVD's and multiple televisions often finds that the discs are scattered around the house, and a particular DVD she wants to watch often cannot be readily located. Some users also consider it inconvenient to have to load a DVD into a player and unload it after playback every time she desired to view that DVD. A DVD jukebox provides a solution to these problems. A “jukebox” typically refers to a playback device that has a plurality of storage medium units (e.g., LP's, CD's, or DVD's) containing commercially available titles loaded therein that can be selectively played on-demand. Some DVD jukeboxes can store hundreds of discs, allowing a user to store her entire collection of video titles in one machine. Since the discs are physically stored in the jukebox, the hassle of repeatedly loading and unloading DVD's for watching is avoided.

Although DVD jukeboxes provide some significant conveniences, they also have some disadvantages. First, the user has to keep track of all the titles loaded in the DVD jukebox and their respective locations in the machine. The front-panel display of a DVD jukebox machine typically shows very limited information about what is stored in the machine and does not provide a convenient way for the user to view and navigate through the titles stored in the machine. Moreover, a DVD jukebox is typically connected to only one television and can only play the DVD's on that television. If the user wants to watch a DVD on another television at a different location, she has to take that DVD out of the jukebox, walk over to the other television, and play the disc on another DVD player connected to that television. The operation of loading discs into and unloading discs from a jukebox is, however, typically very cumbersome and inconvenient. Moreover, moving discs in and out of the jukebox too frequently can cause the user to lose track of which titles are in the jukebox. Physical handling of DVDs can also cause scratches to the discs, especially when kids are present.

In the meantime, the number of home networks has being growing rapidly. The prices of personal computers and networking devices have come down tremendously, and it is very easy for a household with multiple computers to set up a home network. As a result, computer networking is no longer limited to work places and has entered many homes. The availability of home networking has opened many possibilities for home entertainment. Such possibilities, however, are mostly unrealized at this time. Many users implement home networks mainly for the purpose of being able to access the Internet from different computers in the home and to share data and programs among the home computers, and the aspect of information/data access is largely independent of and unrelated to other aspects of home activities and functions.

### SUMMARY OF THE INVENTION

In view of the foregoing, the present invention provides system and method for integrating home entertainment with home networking functionality that enables a jukebox (e.g., a DVD jukebox or the like) to serve as a centralized storage of multiple video/audio titles that can be selected from and played on televisions or other display devices at different locations in the home. The home entertainment system in accordance with the invention includes a media server residing on the home network, and the jukebox is connected to the media server via a two-way digital link. The media server controls the jukebox and functions as its proxy to allow discovery and control of the jukebox by other devices, such as media clients for televisions, on the home network. The media server keeps track of the titles loaded in the jukebox and generates and caches a directory of the titles stored in the jukebox that can be presented to a user for the user to navigate the titles and select a title for viewing on a display device, such as a television, that has a media client connected to the home network. The media client discovers the jukebox device on the home network and presents a jukebox option in a menu. Upon selection of the “jukebox” option by a user, the media client loads the jukebox title directory compiled and cached by the media server and displays the directory in an interactive user interface on the display device to enable navigation of titles in the jukebox for obtaining information of the titles and selecting a title for viewing on the display device. The title information that the media server obtains directly by accessing the jukebox may be augmented by additional information obtained from the internet.

### BRIEF DESCRIPTION OF THE DRAWINGS

FIG. 1 is a block diagram generally illustrating an exemplary computer system on which a media server may be implemented in an embodiment of the invention for integrating a home entertainment system with a home network;

FIG. 2 is a schematic diagram showing an embodiment of a home entertainment system that is integrated with a home network and has a video jukebox to provide enhanced media service user experience in accordance with the invention;

FIG. 3 is a schematic diagram illustrating exemplary user interface pages for a user to interactively navigate and select titles stored in a jukebox connected to the home network; and

FIG. 4 is a flow diagram summarizing the operation of the home entertainment system for a user to view titles stored in the video jukebox through the home network.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

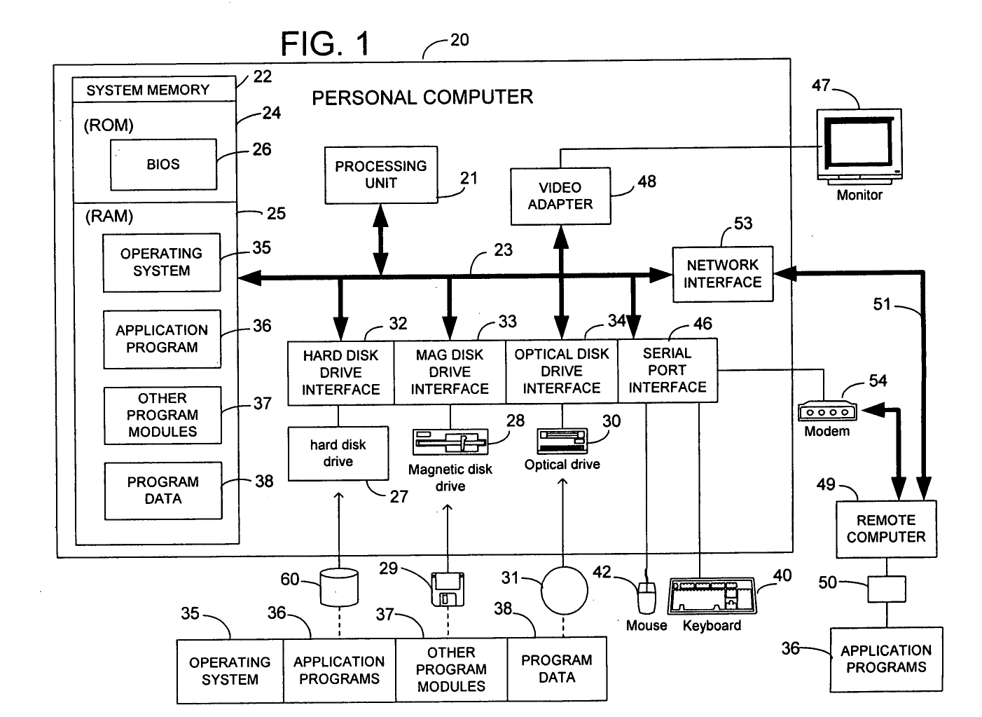

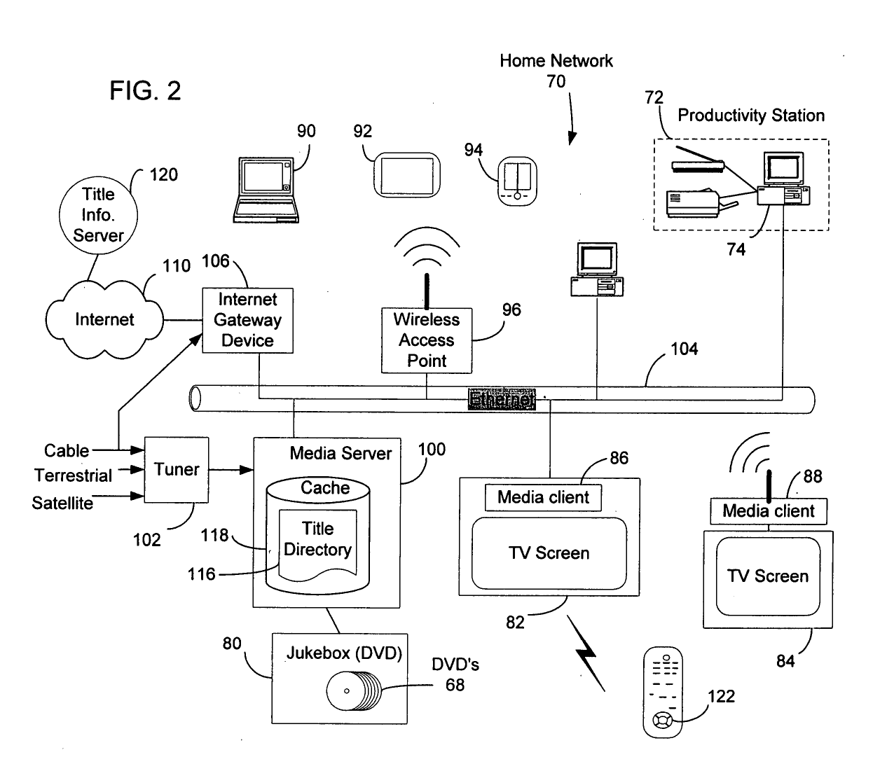

The following description begins with a description of a general-purpose computing device that may implement components of a home network of the invention for integrating data access and home entertainment. The home entertainment architecture of the invention that enables the viewing of titles stored in a jukebox on display devices such as televisions at different locations in the home will be described in greater detail with reference to FIGS. 2-4. Turning now to FIG. 1, a general purpose computing device is shown in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various ones of the acts and operations described hereinafter may also be implemented in hardware.

Referring now to FIG. 2, the present invention is directed to an integration of a home network 70 with home entertainment components to provide enhanced home entertainment experience. In particular, the present invention provides a home entertainment system based on a home network that enables a user to select and view titles stored in a jukebox 80 on televisions 82, 84 or other display devices or audio playback systems located at different places in the house without the need for direct analog signal connections to the jukebox. As used herein, the term “jukebox” means a video/audio playback device that provides physical storage space for multiple storage medium units and has the mechanism for picking out each storage medium unit and retrieving the digital data on that storage medium unit. The storage medium units may be, for instance, Digital Video Discs (DVD's), Compact Discs (CD's), etc., and storage units of other formats that may be developed in the future, such as optical discs for high-definition video signals. In the following description, the invention will be described in connection with an embodiment in which the jukebox is a DVD jukebox 80 and has a plurality of DVD's 68 stored therein. It will be appreciated, however, that a DVD jukebox is only one example, and jukeboxes for other types of storage media for video/audio signals may also be used in the home entertainment system in accordance with the invention.

In the example illustrated in FIG. 2, the home network 70 connects devices for work and entertainment functions. For instance, a productivity station 72, which may be located in the study room of the house, includes a desktop personal computer 74 that may be connected to the home network via wired or wireless connections. An entertainment center 76, which may be located in the family room, contains video/audio equipment including a television 82. As described in greater detail below, the television 82 has a television client component 86 that is connected to the home network 70. Another television 84, which may be located in the bedroom, is also connected to the home network 70 by its media client component 88. In a preferred embodiment, the home network is built on an IP-based Ethernet network 104. The home network 70 may also have wireless devices connected thereto. To that end, the home network 70 includes one (or more) wireless access point (WAP) 96 that functions as the base station for a wireless local area network (LAN) and is typically plugged into an Ethernet hub or server. The wireless communications allows a user to move around the house with her mobile device without losing connection to the home network. The wireless devices include, for example, a notebook computer 90, a tablet PC 92, a PDA 94, etc.

In accordance with a feature of the invention, the home network further includes a media server 100 and a jukebox 80. The media server and the jukebox may be located, for instance, in an equipment room. In a preferred embodiment, the media server 100 is implemented in a personal computer. Alternatively, the media server may be a dedicated microprocessor-based device, similar to a set-top box, with adequate hardware and software implementing media service related functions. The media server 100 may be connected to various video/audio signal sources, such as a tuner 102, which may receive signals from different carries such as satellite, terrestrial, or cable (broadband) connections. The media server 100 is preferably provided with capabilities to access the Internet 110. In the illustrated embodiment, the media server is connected to an Internet gateway device (IGD) 106, which may be connected to the Internet via cable or a phone line (i.e., publicly switched telephone network (PSTN)). In the illustrated example, the Internet gateway device 106 is also used by the personal computer 74 in the productivity station 72 to access the Internet 110.

The media server 100 enables integration of the home entertainment components/devices with the home network 70 to provide enhanced home automation experience. In particular, in accordance with the invention, the media server 100 enables the contents of the jukebox 80 to be selected and viewed on display devices at different locations in the house. The display devices include the televisions 82 and 84, and may include other devices that present a suitable image for viewing, such as the personal computer 74, the notebook 90, the tablet PC 92, and the PDA 96. To that end, the jukebox 80 is connected to the media server 100 via a two-way digital link 112 to allow the media server to communicate with and control the jukebox. The two-way digital link 112 may be, for example, a “firewire” connection based on the IEEE 1394 standard, or a Universal Serial Bus (USB) connection.

The media server 100 functions as a proxy for the jukebox 80 to allow the jukebox to be discovered and controlled by other devices connected to the home network 70, such as the media clients 86, 88 of the televisions 82, 84, as described in greater detail below. Upon loading of the DVD jukebox 80, the media server 100 queries the DVD jukebox 80 to check every loaded DVD title in the jukebox, and generates a rich set of user interface data that includes metadata to provide information about the loaded titles that can be used to assist a user to easily and simply navigate and select the titles. To that end, the media server 100 preferably has access to the Internet 110. For each title stored in the DVD jukebox 80, the media server 100 may go to a predefined title information server 120 on the Internet 110 and retrieve information (i.e., meta data) regarding that particular title, if the information is available. In one implementation, the media server retrieves a predefined number of the initial bits on each DVD, and uses a hash of those bits as an identification of the title when it goes to the information server 120 for information about that title. In a preferred embodiment, the media server 100 then uses the downloaded information to build a user-friendly directory 116 of the titles loaded in the DVD jukebox 80. The title directory 116 is stored in a cache 118 of the media server. Upon demand by a user situated in front of a television 82, the media server sends the title directory 116 and other user interface data to the media client 86 of the television for display on the television to allow the user to interactively navigate the titles and select a title for playback. The use of information downloaded from the Internet 110 for the titles in the jukebox 80 allows the media server 100 to present a user interface with rich information. Moreover, the title directory compiled by the media server may include “hotlinks” to the Internet for augmenting the DVD titles with related information on websites.

When the user selects a title for viewing, the media server 100 controls the DVD jukebox 80 to read the contents on the DVD for that title, and transmits the contents to the media client of the display device (e.g., a television) being viewed by the user via the home network. In a preferred embodiment, the media server 100 performs any necessary changes and conversions, such as transcoding, transcripting, and/or adaptations, on the contents data to put the data in an optimal format for either transmission over home network or for viewing on the given display device. “Transcoding” generally refers to changing the encoding of the data. For instance, the media server 100 may transcode the MPEG2 data read from the DVD into another format, such as WMV9, that uses a more efficient encoding method to reduce the amount of data to be transmitted over the home network by a factor of 3. “Transcripting” refers generally to changing the data encryption from one security scheme (e.g., over a digital link) to another (e.g., over the home IP network). The media server 100 may transcript the contents of the digital signal from one content protection scheme as it arrives from the jukebox to an appropriate protection scheme for transmission over the IP home network, so that the content continues with the protection level intended by the publisher of the content. In contrast to transcoding and transcripting, “adaptations” may generally be applied to the contents data to suit the characteristics of the target device. For example, the adaptation may include mapping from one aspect ratio (e.g., 16:9) to another (e.g., 4:3) using some user specified policies, or converting the resolution from high-definition (e.g., 1920×1080i) to standard-definition (e.g., 640×480i). In addition to adapting contents of the DVD's, the media server may also adapt the user interface pages it has compiled to better fit the display of the device invoking the “jukebox” functionality and then transmit the adapted pages to the display device. The various types of conversions applied to the contents data may be performed automatically or according to predefined policies set by the user.

Still referring to FIG. 2, each of the televisions 82, 84 has a media client 86, 88 that is connected to the home network 70 to enable the user to invoke the functionality of the media server. It is expected that the media client components will be integrated natively with future digital televisions. The media client 86, 88 is programmed to present interactive user interface screens in the form or menu screens on different levels according to the selections made by the user in each menu page. On any television in the house that has a media client device connected to the home network 70 and a remote control 122, a user can invoke the viewing the jukebox directory and select a specific title for obtaining more information or for viewing on the television. It will be appreciated that a similar media client component may be provided for any other device with a display, such as a PDA (would be a software component in this case) or a computer, to utilize the functionality provided by the media server 100. The media client of a television is preferably built into the television set, as in the case of the television 82. Alternatively, the media client for a television may be an outboard device, similar to a set-top box, that drives conventional televisions with analog video/audio signals, as in the case of the television 84. Each media client 86 or 88 is programmed to automatically discover the jukebox 80 that is proxied by the media server 100 on the home network 70. When it discovers the existence of the jukebox 80, it populates a local menu with the “jukebox” option that can be selected by the user by pressing buttons on the remote control 122.

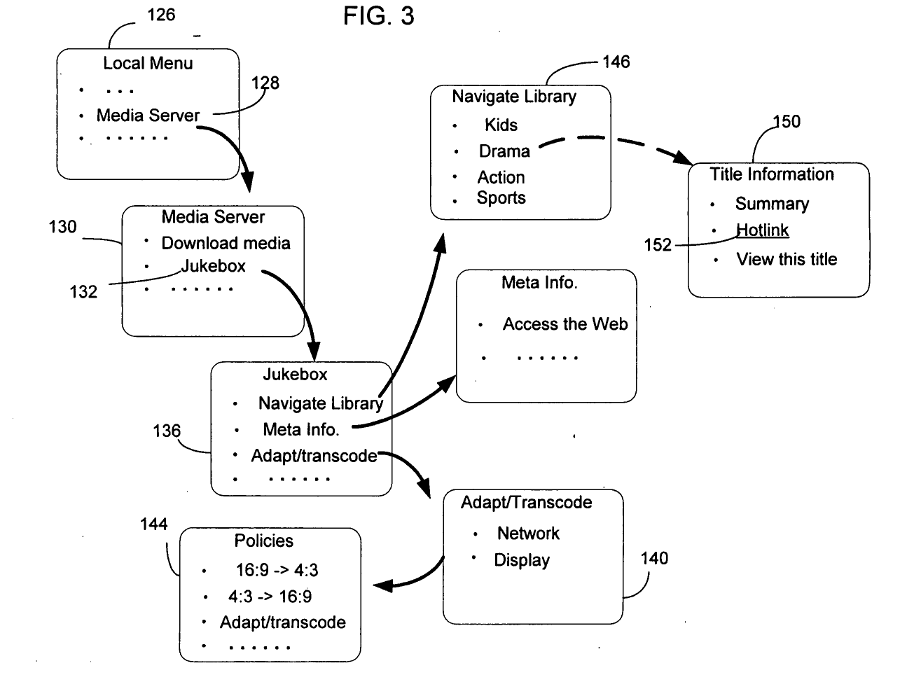

Turning now to FIG. 3, in one exemplary implementation, the local menu of the media client has a starting page 126 that presents a menu option 128 of “media server.” When the user viewing the television 82 uses the remote control to select that option, the media client receives the command and displays the next menu page 130 that includes the option 132 of “DVD jukebox.” When the user selects the “jukebox” option, the media client 86 connects to the media server 100 and retrieves the user interface data, including an up-to-date title directory 116, that was compiled by the media server and saved in its cache 118 for instant availability. The media client 86 then displays the interface pages for the jukebox for viewing by the user to enable the user to navigate through the titles of the discs loaded in the jukebox. For example, the starting menu page 136 for the jukebox may contain options such as navigating the title library, viewing meta information for the titles, adapting presentation, etc. When the user selects one option, the media client 86 then displays the menu page on the next level. For instance, if the user selects “adapting presentation,” the next menu page 140 presents options of adapting the presentation according to network characteristics or television (or display) characteristics. When the user selects the option of adapting based on display characteristics, the next page 144 allows the user to select adaptation policies, such as specifics of conversion from 4:3 to 16:9, etc. When the user selects the “Navigate Library” option in the page 136, the next menu page 146 may present a list of categories based on the contents of the titles, such as “kids,” “drama,” “action,” etc. Moreover, for a given title, the user interface page 150 may present a “hotlink” 152 that links to additional information for that title on the Internet 110. In a preferred embodiment, the media client has built-in web browser functionality. If the user selects the hotlink 152, the media client 86 downloads the information at that link from the Internet and displays the additional information on the television 82 for viewing by the user.

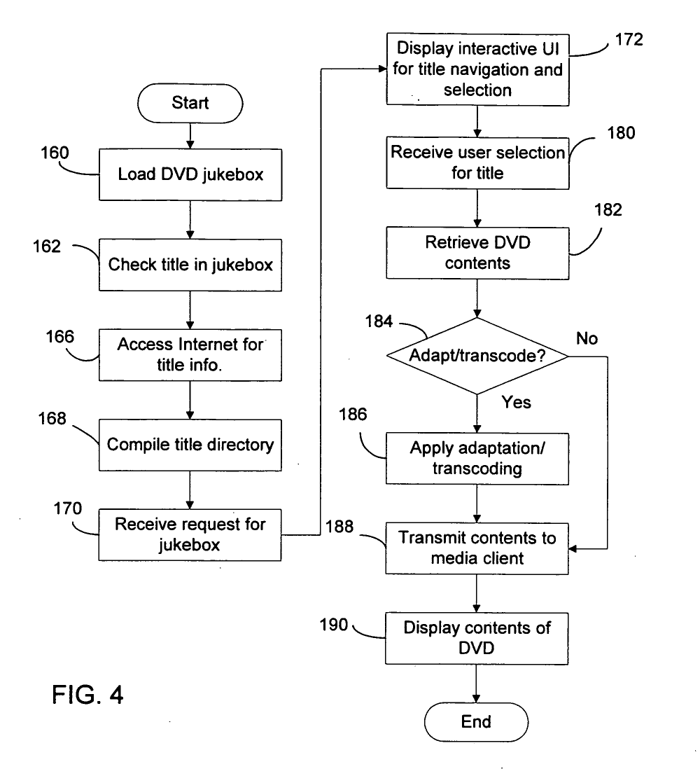

The operations of the media server 100, DVD jukebox 80, and media client 86 for allowing the viewing of titles stored in the DVD jukebox on televisions connected to the home work are summarized in FIG. 4. Upon loading of the DVD jukebox (step 160), the media server queries the jukebox to check the titles loaded in the jukebox (step 162), and generates a directory of the loaded titles (step 168). This may involve going to certain websites on the Internet to retrieve meta information for each of the titles (step 166). When the user invokes the jukebox functionality through the local menu presented on the television by the media client (step 170), the media client retrieves the title directory compiled by the media server and displays the directory as a sequence of interactive user interface menus for navigation and selection by the user (step 172). When the user selects to view a title (step 180), the media client sends the request to the media server, and the media server controls the DVD jukebox to retrieve the contents for that title (step 182). If any content adaptation or transcoding is required (step 186), the media server performs the adaptation or transcoding (step 186), and sends the resultant data over the home network to the media client (step 188), which then displays the contents on the television (step 190).

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

1-26. (canceled)

27. A method of sharing titles on a home network media server, the method comprising:
establishing a two-way digital connection with a jukebox, the jukebox having a plurality of titles stored therein;
querying the jukebox for information regarding titles stored in the jukebox;
compiling and caching a title directory for the titles stored in the jukebox;
receiving a request to use the jukebox from a media client on the home network, the media client being connected to a display device;
sending the title directory to the media client for presenting an interactive user interface on the display device;
receiving a request from the media client for a selected title in the jukebox;
retrieving contents of the selected title from the jukebox; and
transmitting the contents of the selected title to the media client for display on the display device.

28. The method of claim 27 wherein the step of compiling the title directory further comprises accessing the Internet for downloading additional information for a title stored in the jukebox, and presenting the downloaded information in the title directory.

29. The method of claim 28 wherein the title directory includes a link to an Internet site containing information for a title stored in the jukebox.

30. The method of claim 27 further comprising presenting the jukebox to the home network for discovery by other devices connected to the home network.

31. The method of claim 27 further comprising converting the contents of the selected title and wherein the step of transmitting transmits the converted contents to the media client.

32. The method of claim 31 wherein the step of converting adapts the contents of the selected title based on display characteristics of the display device connected to the media client.

33. The method of claim 31 wherein the step of converting further comprises transcoding the contents of the selected title for transmission over the home network.

34. A method for selecting and displaying a title on a home network media server, the method comprising:
presenting on the display device an option to use a jukebox for selection by the user, the jukebox being connected to the home network via a media server;
receiving a first user input signal selecting the option to use the jukebox;
querying the media server connected to the jukebox for information on titles stored in the jukebox;
receiving from the media server the information on titles stored in the jukebox;
presenting an interactive user interface on the display device to present the information on the titles stored in the jukebox;
receiving a second user input signal requesting viewing of a selected title in the jukebox;
requesting the media server for contents of the selected title;
receiving the contents of the selected title from the media server; and
displaying the contents of the selected title on the display device.

35. The method of claim 34 wherein displaying further comprises sending analog video signals to the display device.

36. The method of claim 34 wherein the media client is built into the display device.

37. The method of claim 34 wherein presenting an interactive user interface further comprises displaying menus on different levels in accordance with received user input signals.

38. The method of claim 34 further comprising discovering the jukebox on the home network through the media server.

39. A media server comprising:
a two-way digital connection with a jukebox having at least one title stored therein and a connection to a home network; wherein the media server compiles a title directory for the titles stored in the jukebox, sends the title directory over the home network to a media client, retrieves contents of a selected title from the jukebox, and transmits the contents of the selected title over the home network to the media client.

40. The media server of claim 39 wherein the jukebox is integrated into the media server.

41. The media server of claim 39 wherein the jukebox is separate from the media server.

42. The media server of claim 39 further comprising a wide area network connection device connected to the home network.

43. The media server of claim 42 wherein the media server is further programmed to access a wide area network for downloading information for a title stored in the jukebox.

44. The media server of claim 39 wherein the title directory includes a link to an Internet site containing additional information for a title stored in the jukebox.

45. The media server of claim 39 wherein the media server is further programmed to convert the contents of the selected title.

46. The media server of claim 45 wherein the media server is further programmed to transmit the converted contents of the selected title over the home network.
